(19) United States
(12) Patent Application Publication
(10) Pub. No.: US 2023/0269841 A1
(43) Pub. Date: Aug. 24, 2023

(54) Method And Apparatus For LED Light Control

(71) Applicant: LED One Corporation, Eastvale, CA (US)

(72) Inventor: Zhang Wei, Nanjing City (CN)

(21) Appl. No.: 17/678,663

(22) Filed: Feb. 23, 2022

(51) Int. Cl. H05B 45/10; F21K 9/238

(52) U.S. Cl. CPC H05B 45/10; F21K 9/238

(57) ABSTRACT

A light emitting diode (LED) lighting device comprises an LED light source, a socket base, and a dimmer control circuit. The socket base is connected to the LED light source and includes a power supply terminal. The dimmer control circuit is housed within the socket base. The dimmer control circuit is electrically coupled to the power supply terminal. The dimmer control circuit comprises an LED driver and a dimmer controller. The LED driver is configured to supply driving power to the LED light source from the power supply terminal. The dimmer controller is configured to receive a plurality of inputs indicative of an “on” state and an “off” state of a switch. The dimmer controller is further configured to send a signal to the LED driver to adjust the driving power to affect a brightness of the LED light source based on the plurality of inputs.

### TECHNICAL FIELD

This disclosure relates generally to LED light control, more particularly, to a dimmer control for an LED lighting device.

### BACKGROUND

Light Emitting Diodes (LEDs) are desirable for use in lighting fixtures due to the efficiency and reliability of LEDs. LEDs used for interior lighting are typically high output devices that emit light that is a “pure” white (or nearly white) color. This color and output level work well for situations where bright lighting is desired. Some modern LED interior lights have a dimming feature for when lower light levels are desired.

Conventional LEDs with a dimming feature include a dimmer power switch and/or additional circuitry to control the amount of electrical energy that passes to the LED. An example of a dimmer power switch is a 0-10 V dimmer. The 0-10 V dimmer controls direct current (DC) voltage between 0 and 10 volts to produce light at varying intensity levels. At 0 volts, the LED is at a minimum brightness, and at 10 volts, the LED is at a maximum brightness. Another example of a dimmer power switch is a phase-cut switch. Phase-cut dimming works by modulating an input power signal to reduce the power to the LED. The signal is reduced (e.g. chopped) so that the LED experiences a lower voltage resulting in a lower light output.

To install the dimming feature requires replacing a standard power switch with the dimmer power switch or adding dimmer circuitry between the power switch and the LED. The installation can be time consuming, complicated, and in certain situations, require the help of a professional electrician.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein.

### SUMMARY

The foregoing needs are met, to a great extent, by the LED lighting device described herein. As will be further explained herein, the LED lighting device can include a microcontroller unit (MCU) module and an integrated circuit (IC). The MCU module can be integrated into an LED light source and can detect a number of alternating current (AC) inputs from a power switch. After the MCU module detects the number of inputs (e.g. number of times the power switch transitions from “on” and “off”), the MCU module can convert the inputs into different output signals. The main IC, which can be an intelligent power management IC, can identify the signals sent by MCU module and control different brightness levels of LED light source according to the different signals sent by MCU.

An aspect of the present disclosure provides an LED lighting device. The lighting device comprises an LED light source, a socket base, and a dimmer control circuit. The socket base is connected to the LED light source and includes a power supply terminal. The dimmer control circuit is housed within the socket base. The dimmer control circuit is electrically coupled to the power supply terminal. The dimmer control circuit comprises an LED driver and a dimmer controller. The LED driver is configured to supply driving power to the LED light source from the power supply terminal. The dimmer controller is configured to receive a plurality of inputs indicative of an “on” state and an “off” state of a switch. The dimmer controller is further configured to send a signal to the LED driver to adjust the driving power to affect a brightness of the LED light source based on the plurality of inputs.

Another aspect of the present disclosure provides a method for controlling a brightness of the LED lighting device. The method comprises: supplying the driving power to the LED light source; receiving, by the dimmer controller, the plurality of inputs indicative of the “on” state and the “off” state of the switch; and sending the signal from the dimmer controller to the LED driver to adjust the driving power to affect the brightness of the LED light source based on the plurality of inputs.

Another aspect of the present disclosure provides a dimmer control circuit for an LED lighting device. The dimmer control circuit comprises an LED driver and a dimmer controller. The LED driver is configured to supply driving power to an LED light source from a power supply terminal. The dimmer controller is configured to receive a plurality of inputs indicative of an “on” state and an “off” state of a switch. The dimmer controller is configured to send a signal to the LED driver to adjust the driving power to affect a brightness of the LED light source based on the plurality of inputs. The dimmer control circuit is sized to be housed within a socket base of the LED light source.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there are shown in the drawings illustrative embodiments of the disclosure. It should be understood, however, that the application is not limited to the precise arrangements and instrumentalities shown. In the drawings:

FIG. 1 illustrates a schematic of a lighting system, according to an aspect of this disclosure.

FIG. 2 illustrates another schematic of a lighting system, according to an aspect of this disclosure.

FIG. 3 illustrates a circuit diagram of a dimmer control circuit, according to an aspect of this disclosure.

FIG. 4 illustrates a flowchart depicting a method for controlling the brightness of an LED lighting device, according to an aspect of this disclosure.

### DETAILED DESCRIPTION

Certain terminology used in this description is for convenience only and is not limiting. The words “lowest”, “highest”, “outward”, “inward”, “upper,” and “lower” designate directions in the drawings to which reference is made. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less. All ranges disclosed herein are inclusive of the recited endpoint and independently combinable (for example, the range of “from 2 to 10” is inclusive of the endpoints, 2 and 10, and all the intermediate values). The terminology includes the above-listed words, derivatives thereof and words of similar import.

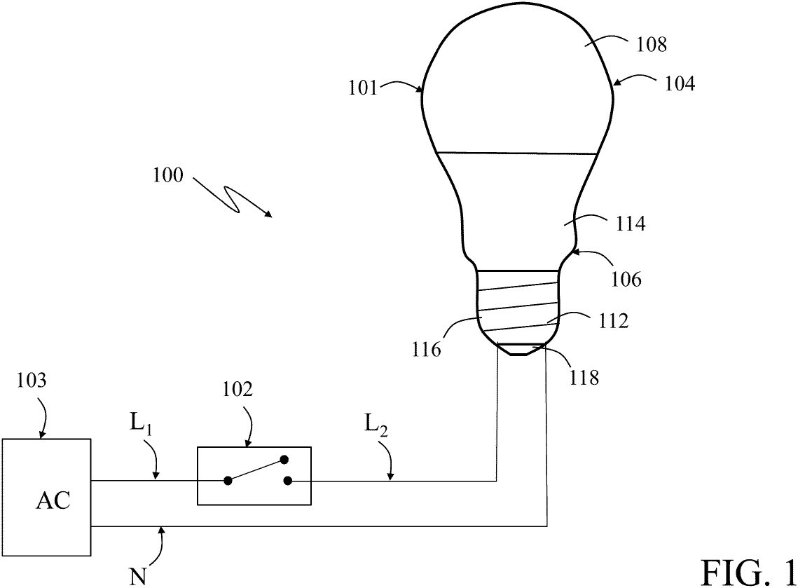

FIG. 1 illustrates a schematic of a lighting system 100, according to an aspect of this disclosure. The lighting system 100 includes an LED lighting device 101 connected to a switch 102. A general lighting device typically uses an alternating current (AC) power source 103 of between 100 VAC and 277 VAC, and in the case where the LED lighting device 101 is used in place of an incandescent light or other general lighting fixture, the LED lighting device 101 is preferably also configured to use a commercial AC 100 V power supply, same as a general lighting fixture.

The AC power source 103 is connected to the LED lighting device via the line wire L₁, the switch 102, the load line L₂, and the neutral line N. The line wire L₁ connects the AC power source into the switch 102. The load line L₂ connects the switch 102 to the LED lighting device 101. The neutral line N can be connected to ground and can carry a current during normal operations.

The LED lighting device 101 can include an LED light source 104, an electric power supply connector (e.g. socket base) 106, and a dimmer control circuit 130. The LED light source 104 can include a cover 108. The cover can comprise a transparent or non-transparent glass or plastic material.

The socket base 106 can include a lower part 112 and an upper part 114. The lower part 112 can comprise, for example, an Edison base used for conventional electric light bulbs. The lower part 112 can be fixed to the upper part 114 of the socket base 106 so that the socket base 106 can be detachable to external electric power supply sockets (not shown).

The lower part 112 can include a first power supply terminal 116 (e.g. a conductive metal screw cap) and a second power supply terminal 118 (e.g. electric contact) positioned at a bottom part of the socket base 106. The first and second power supply terminals 116 and 118 can be insulated from one another. In an aspect, instead of the socket base 106 for electric light bulbs of the Edison base, a socket base of the hook type (not shown) of a well-known swan base may be used, in which the swan base is composed of an insulator and a pair of linear shaped electric terminals. The socket base 106 can include a standard threaded base section for connecting to an electrical socket. It will be appreciated that the socket base 106 can include other socket configurations configured to supply power to the LED light source 104.

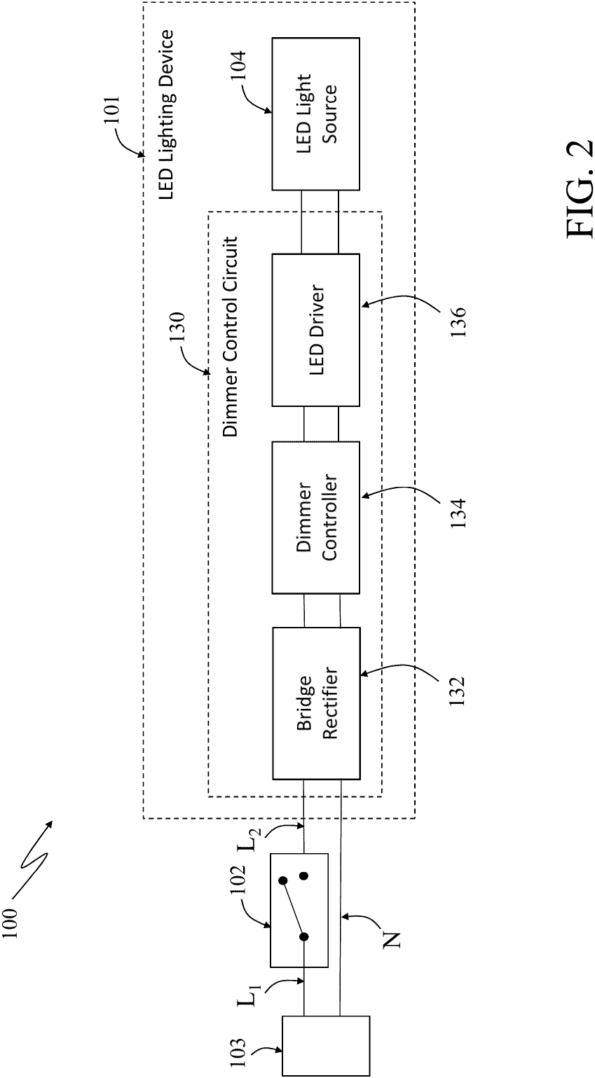

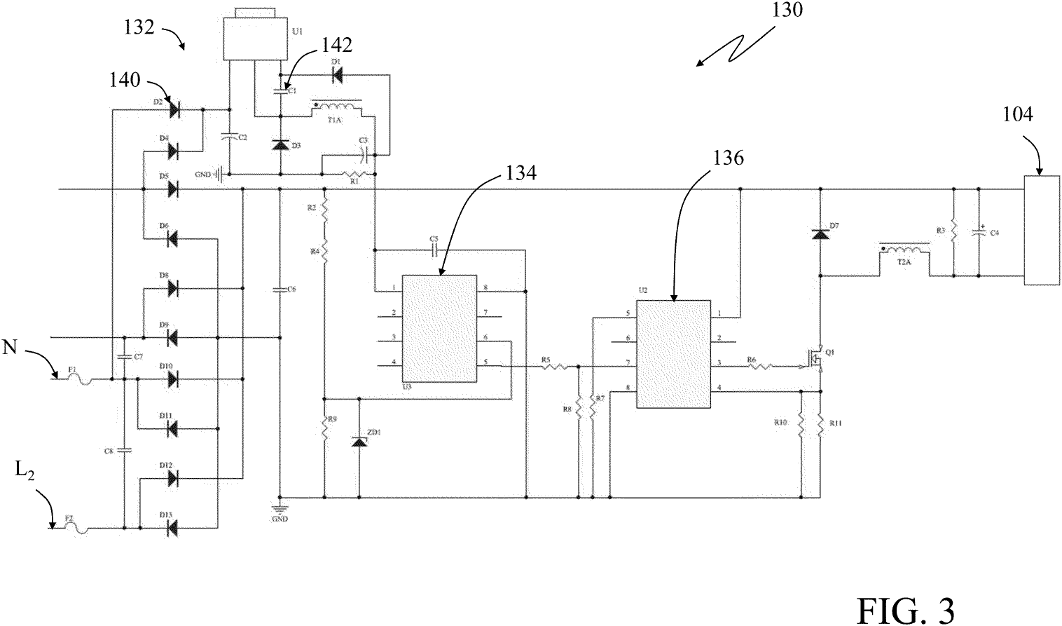

FIG. 2 illustrates another schematic of the lighting system 100 showing the dimmer control circuit 130 positioned within the LED lighting device 101, and FIG. 3 illustrates a circuit diagram of the dimmer control circuit 130, according to aspects of this disclosure. The dimmer control circuit 130 supplies a driving power to the LED light source 104. The dimmer control circuit 130 is sized to be housed in an inner space of the socket base 106. The dimmer control circuit 130 can be positioned within either one of the lower part 112 or the upper part 114, or portions of the dimmer control circuit 130 can be positioned in both of the lower part 112 and the upper part 114. The location and position of the dimmer control circuit 130 within the LED lighting device 101 enables the LED lighting device 101 to be connected to the power source 103 as a single unit. For example, the socket base 106 can be inserted within a socket (not shown) that is connected to the power source 103 and switch 102. A current can be supplied to the LED lighting device 101 via the power source 103 and the socket base 106.

The dimmer control circuit 130 is configured to affect a brightness of the LED light source 104. The dimmer control circuit 130 can include a bridge rectifier 132, a dimmer controller 134, and an LED driver 136. It will be appreciated that the dimmer control circuit 130 can include fewer or more components including, for example, capacitors, diodes, gates, resistors, inductors, or still other components for use in controlling brightness. The dimmer control circuit 130 is connected to the load line L₂ and the neutral line N via the socket base 106.

The bridge rectifier 132 is configured to rectify a provided AC voltage and current for use by the dimmer controller 134 and the LED driver 136. The bridge rectifier 132 can include one or more diodes 140, one or more capacitors 142, or still other components for rectifying an AC voltage. The bridge rectifier 132 can convert the AC current input into a direct current (DC) output that can be supplied to the LED light source 104 to emit short wavelength light. The bridge rectifier 132 can include one of various known rectifying circuits, such as a full-wave rectifying circuit, a half-wave rectifying circuit, or other rectifying circuit.

The dimmer controller 134 is configured to control the dimming of the LED light source 104. The dimmer controller 134 is configured to receive signals indicative of a position of the switch 102. The dimmer controller 134 can record the switch positions and affect a brightness of the LED light source 104 based on the switch positions. The dimmer controller 134 is further configured to send signals indicative of a brightness to the LED driver 136. The dimmer controller 134 can include an integrated circuit or other data manipulation circuit or device that may be used to facilitate control and coordination of any of the methods or procedures described herein. While the dimmer controller 134 is represented as a single unit, in other aspects the dimmer controller 134 can be distributed as a plurality of distinct but interoperating units. The dimmer controller 134 can comprise, for example, an MCU module.

The dimmer controller 134 can include a memory element and a processing element. The memory element and the processing element can be separate elements associated together, or can include an integrated memory processing element. The processing element can be configured to receive and process signals indicative of the switch position and to store the signals in the memory element. For example, the memory element can store a status of the switch 102 (e.g., “on” state and “off” state), a level of brightness (e.g. intensity of power), or other parameters of the circuit during operating modes of the lighting system 100. The memory element can also store, for example, executable instructions including at least one algorithm for controlling the brightness of the LED light source 104.

The dimmer controller 134 can include a dimming “on” state and a dimming “off” state. In the dimming “on” state, the dimmer controller 134 is configured to send a signal to the LED driver 136 to adjust a driving power to the LED light source 104. In the dimming “off” state, the dimmer controller 134 does not send a signal to the LED driver to adjust the driving power to the LED light source 104.

The LED driver 136 is configured to supply the driving power to the LED light source 104 from the power source 103 and to control and/or regulate the current flowing through the LED light source 104. The LED driver 136 is configured to receive signals from the dimmer controller 134 indicative of a brightness level of the LED light source 104. Based on the signals from the dimmer controller 134, the LED driver 136 can adjust the driving power to affect the brightness of the LED light source 104. The LED driver 136 can include an integrated circuit or other data manipulation circuit or device that may be used to facilitate control and coordination of any of the methods or procedures described herein. While the LED driver 136 is represented as a single unit, in other aspects the LED driver 136 can be distributed as a plurality of distinct but interoperating units.

The LED driver 136 can include a processing element configured to receive and process the signals received from the dimmer controller 134. FIG. 3 illustrates that connect function “5” of the dimmer controller 134 is connected to connect function “7” of the LED driver 136. It will be appreciated that the dimmer controller 134 and the LED driver 136 can be configured such that different connect functions connect between the dimmer controller 134 and the LED driver 136. For example, the connect function “7” of the dimmer controller 134 can be connected to the connect function “6” of the LED driver 136. In an aspect, the dimmer controller 134 is connected to the LED driver 136 at a dimming control function (DIM) of the LED driver 136. The connect functions can include, for example, a high voltage (HV), no internal connection (NC), a reverse over voltage connection (ROVP), the dimming control function (DIM), a ground (GND), a current sensing function (CS), or still other connect functions. The LED driver 136 can also receive and process signals sent from, for example, the switch 102, the bridge rectifier 132, or other components.

During operation, a user can control the switch 102 to transition the LED light source 104 between an “on” state and an “off” state. In the “on” state, the switch 102 is closed allowing the power source 103 to supply power to the LED lighting device 101 via the line wire L₁ and the load line L₂. In the “off” state, the switch is open, disconnecting the line wire L₁ from the load line L₂, thereby preventing the power source 103 from supplying power to the LED lighting device 101. The switch 102 can comprise a conventional light switch configured to turn a light on and off. It will be appreciated that the switch 102 can comprise other types of light switches, for example, dimmer switches, toggle switches, push-button switches, or still other types of switches configured to disconnect and connect the line wire L₁ from the load line L₂.

The user can further control the switch 102 to affect the brightness of the LED light source 104. For example, the LED light source 104 can include a plurality of brightness levels, for example, 0% through 100%, with 100% being the most bright, 50% being half as bright as 100%, and 0% being the least bright (e.g. no current supplied to the LED light source). The user can affect the brightness by transitioning the switch 102 between the “on” and “off” state to start dimming, lock the dimming level, and to reset dimming, as further explained below.

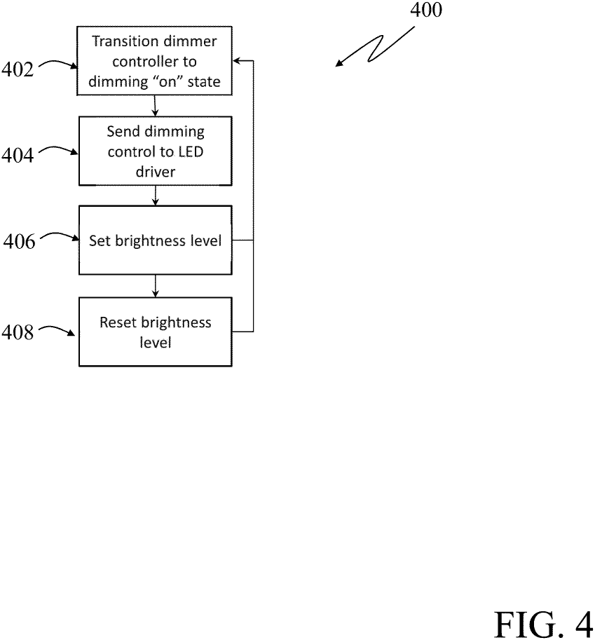

FIG. 4 illustrates a flowchart depicting a method 400 for controlling the brightness of the LED lighting device 100, according to an aspect of this disclosure. The initial conditions of the LED lighting device 100 include the switch 102 being in the “off” state, the dimmer controller 134 in the dimming “off” state, and the dimming level of the LED light source 104 that is stored in the memory element of the dimmer controller 134 is set to 100%. The algorithms for affecting the brightness of the LED light source 104 can be stored in the memory element and executed by the processing element of the dimmer controller 134. When the switch 102 is transitioned to the “on” state, the dimmer controller 134 sends a signal to the LED driver 136 to provide power to the LED light source 104 with a brightness of 100%. In response, the LED driver 136 provides the driving power to the LED light source 104 to produce a 100% brightness of the LED light source 104.

At step 402, the dimmer controller 134 is transitioned from the dimming “off” state to the dimming “on” state. The dimmer controller 134 can transition to the dimming “on” state by transitioning the switch 102 between the “on” state and the “off” state multiple times (e.g. plurality of inputs) in rapid succession. For example, the switch 102 can be transitioned from the “off” state to the “on” state and back to the “off” state, and then again to the “on” state and back to the “off” state for a total of four inputs (e.g. double tap or double toggle of the switch 102). In other words, the switch 102 can be transitioned between the “on” and “off” states twice to transition the dimmer controller 134 to the dimming “on” state. Each transition between the “on” and “off” states of the switch 102 can be performed in rapid succession. In an aspect, the rapid succession can be defined as the switch 102 being in each state for less than 1 second. In this aspect, to transition the dimmer controller 134 to the dimming “on” state by transitioning the switch to the “on” and “off” states twice can take less than 3 seconds. It will be appreciated that the time defining the rapid succession can be stored in the memory element of the dimmer controller 134. In an aspect, the time defining the rapid succession can be changed to either increase the time between transitioning the switch 102 or decrease the time between transitioning the switch 102 to cause the dimmer controller 134 to transition to the dimming “on” state.

It will be appreciated that the dimmer controller 134 can be transitioned to the dimming “on” state by other combinations of the switch 102. For example, the dimmer controller 134 can be transitioned to the dimming “on” state by transitioning the switch 102 to the “on” state, to the “off” state, and back to the “on” state (e.g. 1.5 switch transitions) in rapid succession. In another example, the dimmer controller 134 can be transitioned to the dimming “on” state by transitioning the switch 102 to the “on” state, to the “off” state, back to the “on” state, back to the “off” state, and back to the “on” state (e.g. 2.5 switch transitions) in rapid succession.

At step 404, after the dimmer controller 134 is transitioned to the dimming “on” state, the dimmer controller 134 sends a signal to the LED driver 136 to adjust the driving power to the LED light source 104 to affect the brightness of the LED light source 104. For example, since the initial condition of the brightness was set to 100%, when the dimmer controller 134 is in the dimming “on” state the dimmer controller 134 can send a signal to reduce the brightness to 90%. The decrement for reducing the brightness can be stored in the memory element of the dimmer controller 134. The percentage decrement can include, for example, 1% changes, 5% changes, 10% changes, 20% changes, or still other increments.

When the dimmer controller 134 is in the dimming “on” state, the dimmer controller 134 can continuously send a signal to the LED driver 136 to adjust the driving power to affect the brightness of the LED light source 104. For example, after a predetermined time increment, the dimmer controller 134 can send a signal to the LED driver 136 to decrement and reduce the brightness by another 10%, down to 80% brightness. Then after the predetermined time, the dimmer controller 134 can send another signal to the LED driver 136 to decrement the brightness by another 10%, down to 70% brightness. The dimmer controller 134 can continuously send signals to the LED driver 136 at the predetermined time increments until the dimmer controller 134 is transitioned to the dimming “off” state. The predetermined time increment can be stored in the memory element of the dimmer controller 134. The predetermined time can include, for example, 1 second, such that the dimmer controller 134 sends a signal to the LED driver 136 every 1 second to reduce the brightness of the LED light source 104. It will be appreciated that the predetermined time can include other time increments including, for example, 2 seconds, 3 seconds, 5 seconds, or still other time increments.

If the dimmer controller 134 is still in the dimming “on” state when the brightness level is to be set to 0%, the dimmer controller 134 can send a signal to the LED driver 136 to restart the brightness to 100%. This can allow the brightness level to continuously cycle from bright to dim until the dimmer controller 134 is transitioned to the dimming “off” state. In an alternative aspect, when the brightness level is to be set at 0%, the dimmer controller 134 is transitioned to the dimming “off” state and the previous stored brightness level is sent to the LED driver 136 to set the brightness. For example, if the brightness level is at 100% before the dimmer controller 134 is transitioned to the dimming “on” state, and the brightness level is decremented down to 0% while the dimmer controller 134 is in the dimming “on” state, the dimmer controller 134 can automatically transition to the dimming “off” state and the brightness level can be set back to 100%.

In an alternative aspect, when the dimmer controller 134 is in the dimming “on” state, the dimmer controller 134 can be configured to continuously send a signal to the LED driver 136 at the predetermined time increments to increase the brightness. For example, the dimmer controller 134 can send a signal to the LED driver 136 to increase the brightness by 10% each predetermined time increment. After the brightness level is at 100% brightness, the dimmer controller 134 can send a signal to the LED driver 136 to set the brightness at the lowest brightness, for example, 10%. The dimmer controller 134 can continuously send signals to increment the brightness level to cycle through each of the brightness levels until the dimmer controller 134 is transitioned to the “off” state.

At step 406, the brightness level can be set by transitioning the dimmer controller 134 to the dimming “off” state. After the brightness level is decremented to a desired brightness level, the user can transition the dimmer controller 134 to the dimming “off” state. When the dimmer controller 134 is transitioned to the dimming “off” state, the final brightness level that was sent by the dimmer controller 134 to the LED driver 136 is saved in the memory element of the dimmer controller 134. For example, if the dimmer controller 134 decrements the brightness level down to 80% brightness and then is transitioned to the dimming “off” state, the 80% brightness is the final brightness level that is stored in the memory element of the dimmer controller 134. When the switch 102 is transitioned to the “on” state, the LED driver 136 adjusts the driving power to the LED light source 104 to 80% brightness. The 80% brightness level can remain the brightness level until the dimmer controller 134 is transitioned to the dimming “on” state or until the dimmer controller 134 is reset, as discussed further below.

The dimmer controller 134 can be transitioned to the dimming “off” state by transitioning the switch 102 between the “on” and “off” state. For example, if the dimmer controller 134 is transitioned to the dimming “on” state by transitioning the switch 102 from the “off” state, to the “on” state, and back to the “off” state, then again to the “on” state, and then again back to the “off” state in rapid succession (e.g. double tap or double toggle), then the dimmer controller 134 can be transitioned from the dimming “on” state to the dimming “off” state by transitioning the switch 102 from the “off” state to the “on” state. If the dimmer controller 134 is transitioned to the dimming “on” state by transitioning the switch 102 to the “on” state, to the “off” state, and back to the “on” state in rapid succession (e.g. 1.5 switch transitions), then the dimmer controller 134 can be transitioned from the dimming “on” state to the dimming “off” state by transitioning the switch 102 from the “on” state to the “off” state. Stated another way, when the dimmer controller 134 is in the dimming “on” state, a change in the switch 102 position can transition the dimmer controller 134 to the dimming “off” state.

After the dimmer controller 134 is transitioned to the dimming “off” state, the final brightness level is stored in the memory element of the dimmer controller 134. The stored final brightness level is the set brightness level that the LED driver 132 will set the LED light source 104 when the switch 102 is transitioned to the “on” state.

At step 408, the brightness level can be reset to 100% brightness and stored in the memory element of the dimmer controller 134. The brightness level can be reset by transitioning the switch 102 between the “on” and “off” state multiple times. For example, the switch 102 can be transitioned between the “on” and “off” states three times, for a total of six inputs to the dimmer controller 134, to reset the brightness level. It will be appreciated that other combinations of inputs from the switch 102 can also be used to reset the brightness level. When the brightness level is reset, the dimmer controller 134 can store the 100% brightness level as the final brightness level in the memory element, such that when the switch is transitioned to the “on” state, the LED driver 136 provides driving power to the LED light source 104 to set the brightness level at 100%.

The lighting system 100 allows a user to dim the LED lighting device 101 without adding additional dimming wires, circuitry, switches, or other components. The LED lighting device 101 can be inserted into any traditional socket capable of providing power to an LED lighting device. The LED lighting device 101 can include a single unit, that once installed, can allow a user to adjust the brightness by controlling the switch 102 between “on” and “off” states.

It will be appreciated that the foregoing description provides examples of the disclosed system and method. However, it is contemplated that other implementations of the disclosure may differ in detail from the foregoing examples. For example, any of the embodiments disclosed herein can incorporate features disclosed with respect to any of the other embodiments disclosed herein. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

1. A light emitting diode (LED) lighting device comprising:
an LED light source;
a socket base connected to the LED light source, the socket base including a power supply terminal; and
a dimmer control circuit housed within the socket base, the dimmer control circuit being electrically coupled to the power supply terminal, the dimmer control circuit comprising:
an LED driver configured to supply driving power to the LED light source from the power supply terminal; and
a dimmer controller comprising a microcontroller unit (MCU) module including a processor and a memory, the memory storing executable instructions that when executed by the processor, cause the dimmer controller to:
receive a plurality of inputs indicative of an “on” state and an “off” state of a switch;
process the plurality of inputs, and
send a signal indicative of a brightness of the LED light source to the LED driver to adjust the driving power to affect the brightness of the LED light source based on the plurality of inputs.

2. The LED lighting device of claim 1, wherein the dimmer controller is configured to transition between a dimming on state and a dimming off state based on the plurality of inputs, wherein in the dimming on state, the dimmer controller is configured to send the signal to the LED driver to adjust the driving power, and wherein in the dimming off state, the dimmer controller does not send a signal to the LED driver to adjust the driving power.

3. The LED lighting device of claim 2, wherein the dimmer controller is configured such that the plurality of inputs to transition the dimmer controller from the dimming off state to the dimming on state comprises four inputs, wherein the four inputs comprise the switch being transitioned between the “on” state and the “off” state two times.

4. The LED lighting device of claim 2, wherein the dimmer controller is configured to remain in the dimming on state until the dimmer controller receives a signal indicative of the switch in the “off” state.

5. The LED lighting device of claim 4, wherein in the dimming on state, the dimmer controller is configured to continuously send the signal to the LED driver to adjust the driving power to affect the brightness of the LED light source.

6. The LED lighting device of claim 5, wherein in the dimming on state, the dimmer controller is configured to send the signal to the LED driver in predetermined time increments.

7. The LED lighting device of claim 6, wherein in the dimming on state, each signal in which the dimmer controller is configured to send is indicative of a percentage reduction in brightness, such that each signal sent to the LED driver reduces the brightness of the LED light source by the percentage reduction in brightness.

8. The LED lighting device of claim 7, wherein dimmer controller is further configured such that when the switch is transitioned to the “off” state, the brightness of the LED light source achieves a final brightness and the dimmer controller saves the final brightness in the memory.

9. The LED lighting device of claim 8, wherein the dimmer controller is further configured such that when the switch is transitioned to the “on” state the dimmer controller sends a signal to the LED driver to set the brightness of the LED light source to the final brightness stored in the memory.

10. A method for controlling a brightness of the light emitting diode (LED) lighting device recited in claim 1, the method comprising:
supplying the driving power to the LED light source;
receiving, by the dimmer controller, the plurality of inputs indicative of the “on” state and the “off” state of the switch;
processing, by the dimmer controller, the plurality of inputs; and
sending, by the dimmer controller, the signal to the LED driver to adjust the driving power to affect the brightness of the LED light source based on the plurality of inputs.

11. The method of claim 10, further comprising:
transitioning the dimmer controller to a dimming on state from a dimming off state, wherein the step of sending the signal occurs after the dimmer controller is transitioned to the dimming on state.

12. The method of claim 11, wherein transitioning the dimmer controller from the dimming off state to the dimming on state comprises receiving, by the dimmer controller, four consecutive inputs of the plurality of inputs, wherein the four consecutive inputs comprise a first input that includes a first “on” state of the switch, a second input that includes a first “off” state of the switch, a third input that includes a second “on” state of the switch, and a fourth input that includes an “off” state of the switch.

13. The method of claim 12, wherein each of the four consecutive inputs is received by the dimmer controller within one second of the previous input.

14. The method of claim 11, wherein the step of sending the signal from the dimmer controller to the LED driver includes continuously sending the signal to the LED driver while the dimmer controller is in the dimming on state.

15. The method of claim 14, wherein the dimmer controller sends each consecutive signal of the signals sent to the LED driver in predetermined time increments.

16. The method of claim 11, further comprising:
transitioning the dimmer controller to the dimming off state from the dimming on state; and
saving a final brightness of the LED light source to a memory of the dimmer controller, wherein the final brightness of the LED light source is the final brightness that the LED light source achieves before the dimmer controller is transitioned to the dimming off state.

17. The method of claim 16, further comprising:
after transitioning the dimmer controller to the dimming off state, receiving, by the dimmer controller, an input indicative of the “on” state of the switch; and
after receiving the input indicative of the “on” state, sending a signal to the LED driver to set the brightness of the LED light source to the final brightness stored in memory.

18. A dimmer control circuit for a light emitting diode (LED) lighting device, the dimmer control circuit comprising:
an LED driver configured to supply driving power to an LED light source from a power supply terminal; and
a dimmer controller comprising a microcontroller unit (MCU) module including a processor and a memory, the memory storing executable instructions that when executed by the processor, cause the dimmer controller to:
receive a plurality of inputs indicative of an “on” state and an “off” state of a switch;
process the plurality of inputs; and
send a signal indicative of a brightness of the LED light source to the LED driver to adjust the driving power to affect the brightness of the LED light source based on the plurality of inputs,
wherein the dimmer control circuit is sized to be housed within a socket base of the LED light source.

19. The dimmer control circuit of claim 18, wherein the dimmer controller is further configured to transition between a dimming on state and a dimming off state based on the plurality of inputs, wherein in the dimming on state, the dimmer controller is configured to send the signal to the LED driver to adjust the driving power, and wherein in the dimming off state, the dimmer controller does not send a signal to the LED driver to adjust the driving power.

20. The dimmer control circuit of claim 19, wherein in the dimming on state, the dimming controller is configured to continuously send the signal to the LED driver in predetermined time increments to adjust the driving power to affect the brightness of the LED light source.
